(19) United States
(12) Patent Application Publication
(10) Pub. No.: US 2010/0242630 A1
(43) Pub. Date: Sep. 30, 2010

(54) Sample extraction device

(76) Inventor: Sadeq Ahmad Al-Qassem, Adan (KW)

Correspondence Address: LITMAN LAW OFFICES, LTD., POST OFFICE BOX 15035, CRYSTAL CITY STATION, ARLINGTON, VA, 22215, US

(21) Appl. No.: 12/662,779

(22) Filed: May 3, 2010

Related U.S. Application Data
(63) Continuation-in-part of application No. 11/834,007, filed on Aug. 5, 2007.

(51) Int. Cl. G01N 1/10

(52) U.S. Cl. 73/863.11; 73/863.21

(57) ABSTRACT

A device for the automatic extraction of chemical samples is provided. One or more chemical samples are extracted under automatic control for the controlled mixing, heating, cooling, shaking and dispensing thereof. The device includes a housing defining an open interior region. A rotating carousel is disposed within the housing, and a plurality of sample holders are mounted thereon. A plurality of sample storage tanks each contain a unique chemical sample, and a desired volume of at least one chemical sample is drawn from a respective one of the sample storage tanks to a respective at least one of the plurality of sample holders. The carousel is rotated so that the desired volume of the at least one chemical sample may be dispensed into a receptacle positioned adjacent the carousel. The at least one chemical sample may then be mixed, heated, cooled, shaken and/or vibrated within the receptacle prior to dispensing.

### CROSS-REFERENCE TO RELATED APPLICATION

This application is a continuation-in-part of U.S. patent application Ser. No. 11/834,007, filed on Aug. 5, 2007, which is herein incorporated by reference in its entirety.

### BACKGROUND OF THE INVENTION

1. Field of the Invention

The present invention relates to a devices for the extraction of chemical samples, and particularly to a sample extraction device for automating extraction from one or more chemical samples.

2. Description of the Related Art

Traditional laboratory chemical extraction and manipulation has several drawbacks. Liquid-liquid extraction (LLE) is generally used as a pretreatment process to clean up or pre-concentrate a target species prior to chromatographic analysis of organic substances. Similar techniques are applied in a wide variety of analyses and experiments, such as the study of crude oil mixtures and the like. However, the methods that have traditionally been used in the laboratory for liquid chemical extraction require complicated operation processes, a great deal of time, high cost, particularly when it comes to lost or damaged equipment due to human error, health damage due to the use of organic solvents and the like, and high expense involved with the disposal of toxic organic solvents and the like.

Thus, a sample extraction device solving the aforementioned problems is desired.

### SUMMARY OF THE INVENTION

The sample extraction device relates to a device for the automatic extraction of chemical samples. One or more chemical samples may be extracted under automatic control, including controlled mixing, heating, cooling, shaking and dispensing thereof. The device includes a housing defining an open interior region. A rotating carousel is disposed within the housing, the carousel having a plurality of sample holders mounted thereon. A plurality of sample storage tanks may each contain a unique chemical sample, and a desired volume of at least one chemical sample may be drawn from a respective one of the plurality of sample storage tanks to a respective at least one of the plurality of sample holders.

The carousel is controllably and selectively rotated so that the desired volume of the at least one chemical sample may be selectively dispensed into a receptacle positioned adjacent the carousel. The at least one chemical sample may then be mixed, heated, cooled, shaken and/or vibrated within the receptacle prior to selective dispensing thereof.

These and other features of the present invention will become readily apparent upon further review of the following specification and drawings.

### BRIEF DESCRIPTION OF THE DRAWINGS

FIG. 1 is a flowchart illustrating a method of using a sample extraction device according to the present invention.

FIG. 2 is a block diagram diagrammatically illustrating the system components of a sample extraction device according to the present invention.

FIG. 3 is a perspective view of the sample extraction device of FIG. 2.

FIG. 4 is a diagrammatic view of a sample extraction device according to the present invention.

FIG. 5 is a plan view of a control panel for the sample extraction device of FIG. 3.

FIG. 6 is a perspective view of an alternative embodiment of a sample extraction device according to the present invention, the housing being broken away to show the arrangement of components therein.

FIG. 7 is a block diagram illustrating system components of a controller of a sample extraction device according to the present invention.

Similar reference characters denote corresponding features consistently throughout the attached drawings.

### DETAILED DESCRIPTION OF THE PREFERRED EMBODIMENTS

As will be described in detail below, the sample extraction device 1 allows a user to automatically extract chemical samples. Device 1 is preferably provided as an isolated or unitary, integrated system, allowing the user to extract a required quantity of the sample automatically, thus reducing the possibility of human error, in a manner that is relatively quick and has added functionality, such as mixing of multiple samples and applying heating, cooling, stirring, shaking and vibration, as will be described in detail below.

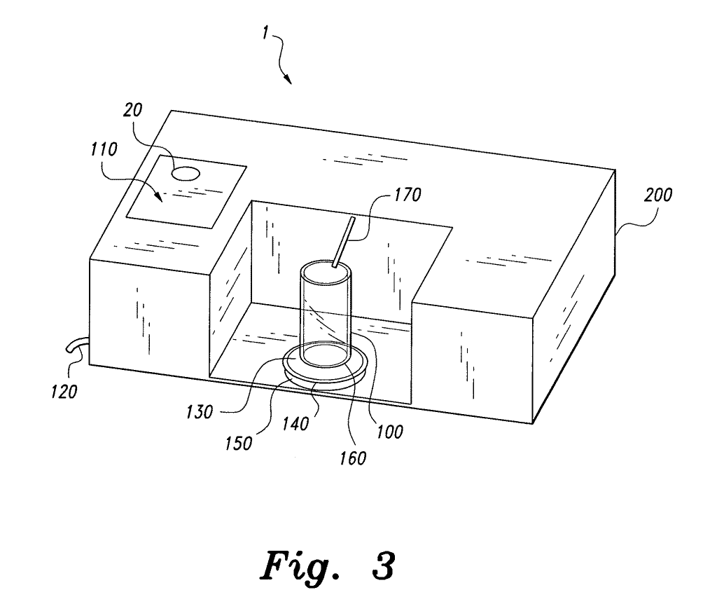

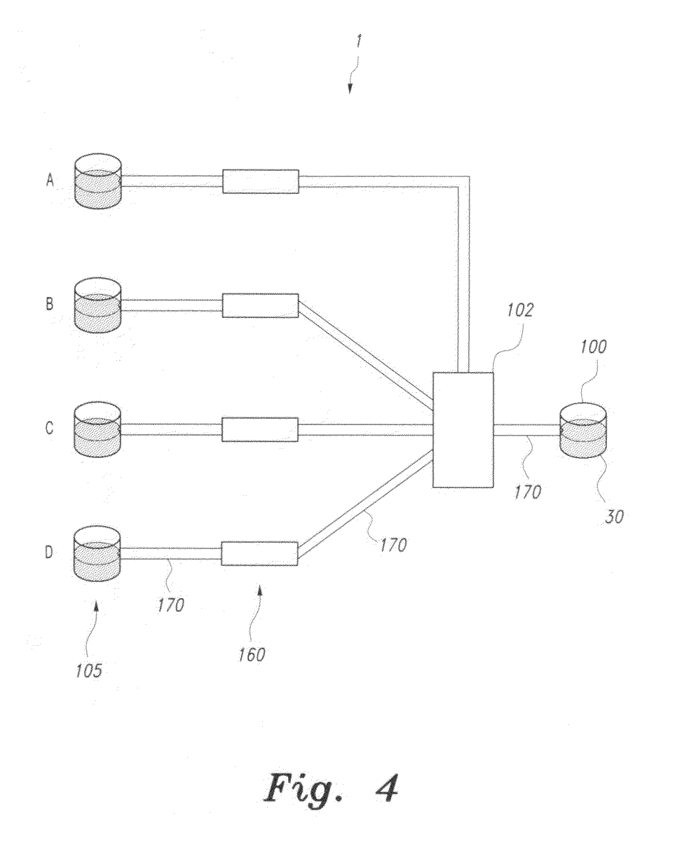

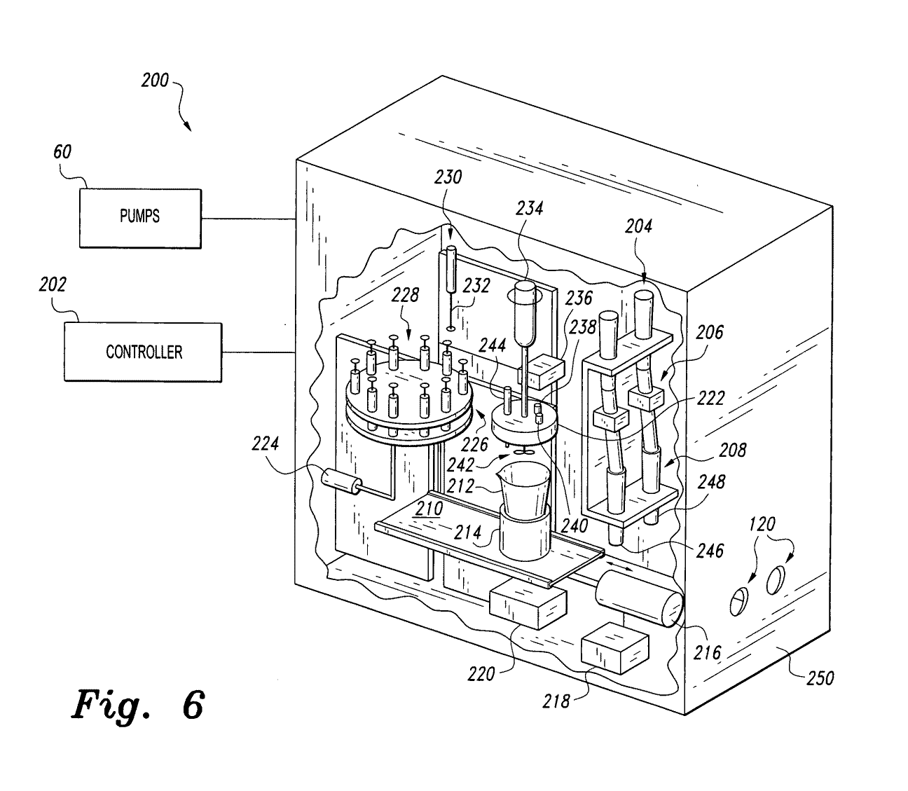

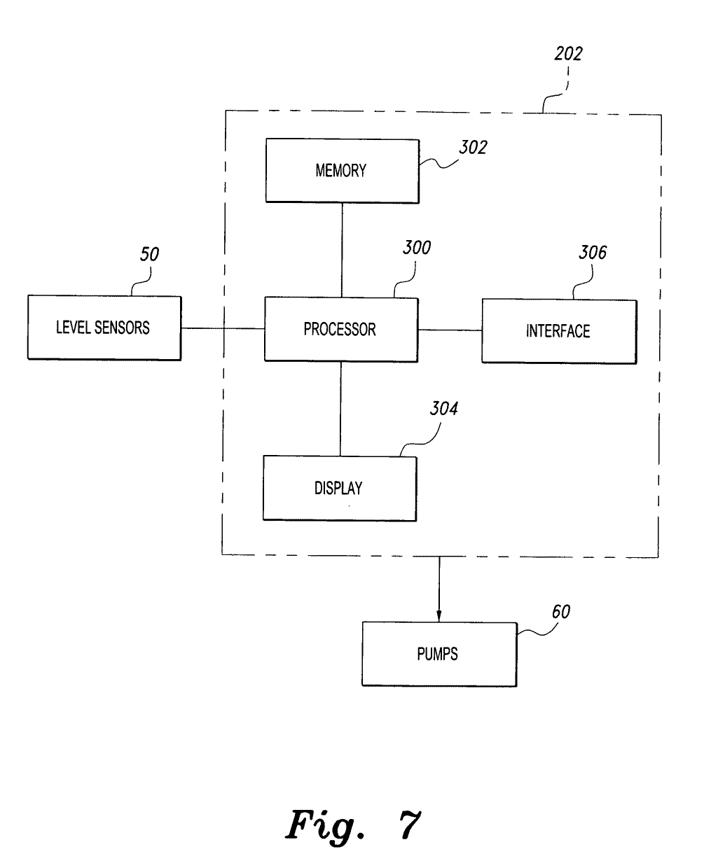

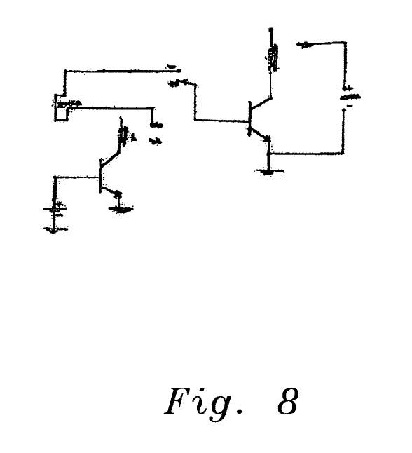

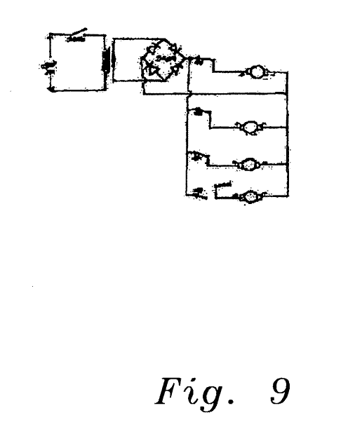

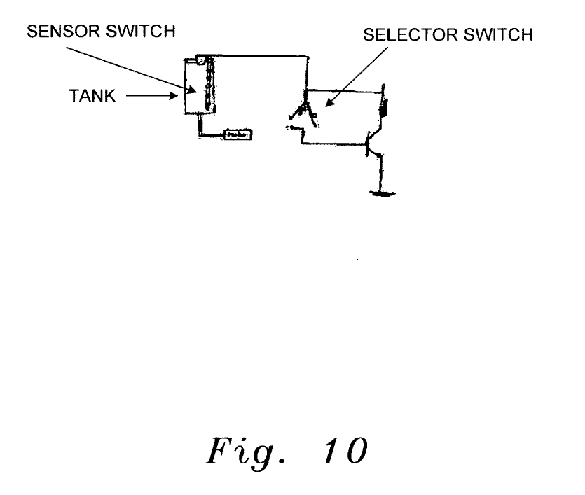

The device 1 is operated by a relatively simple user interface (to be described in greater detail below, particularly with regard to the embodiment of FIG. 6 and FIG. 7). In FIG. 3, the device 1 is shown as having a simple button 20, which is pressed to actuate the device and begin the sample extraction. In FIG. 4, the desired sample is shown diagrammatically as 30, contained within an accumulation tank 100. As will be described in greater detail below, particularly with regard to the embodiment of FIG. 6 and FIG. 7, a controller 202 is provided. The user inputs the chemical properties of the desired sample into the controller 202 (via any suitable interface, as will be described below), along with the desired quantity of the sample, and then presses the operation button 20 to extract the sample, which is collected in accumulation tank 100. If more than one sample is desired (i.e., multiple samples are extracted to produce a mixed end result), the additional samples are extracted at the same time and also placed within accumulation tank 100. As will be described in greater detail below, the device 1, under the control of controller 202, automatically mixes, heats, cools, stirs and/or shakes the sample contained within tank 100, depending upon the desired end product.

FIG. 4 diagrammatically illustrates the device 1, shown having a set of tanks 105, including four tanks, namely tank A, tank B, tank C and tank D. It should be understood that any suitable number of tanks may be provided. In the embodiment of FIG. 6, as will be described in greater detail below, a far greater number of different sample materials may be used. The four tanks A, B, C and D of set 105 each contain a unique chemical sample. Each tank of set 105 is connected to a pump 60, which may be any suitable type of pump under control of controller 202, via a respective conduit 170. The desired samples, in desired volumes, are drawn by conduits 170 (under pressure generated by pumps 60) into a central mixing chamber 102, and then dispensed into accumulation tank 100 as the final product 30.

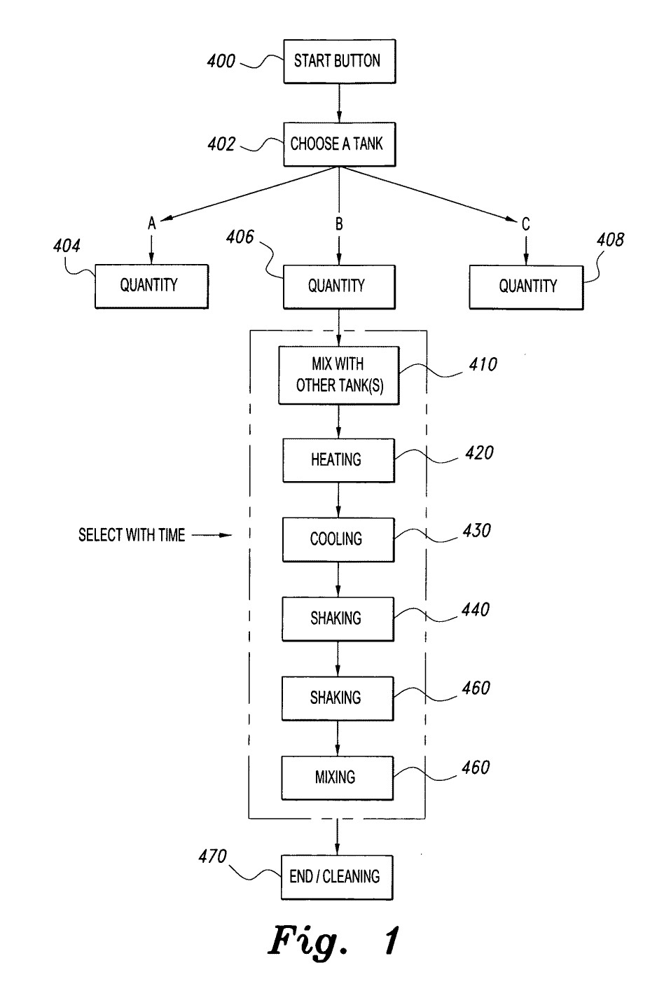

As shown in FIG. 1, the user begins operation by pressing button 20 at step 400. The user may then either manually choose one or more of tanks A, B, C and D of set 105, or the controller 202 automatically determines which samples are required, and in which quantities, depending upon the user's initial input of the desired end product. This choice is made at step 402. In the particular example of FIG. 1, only the samples in tanks A, B and C are required to produce the desired end product 30.

The particular quantities of each are drawn off at 404, 406 and 408, respectively, and delivered into the mixing chamber 102 (of FIG. 4). Mixing occurs at step 410 and any required subsequent heating, cooling, shaking or additional mixing (or stirring) occurs at steps 410, 420, 430, 440, 460, respectively. The user may initiate heating, cooling, shaking or additional mixing (or stirring) manually, or controller 202 may initiate these steps automatically, with particular instructions for the production of varying substances being stored within computer readable memory 302.

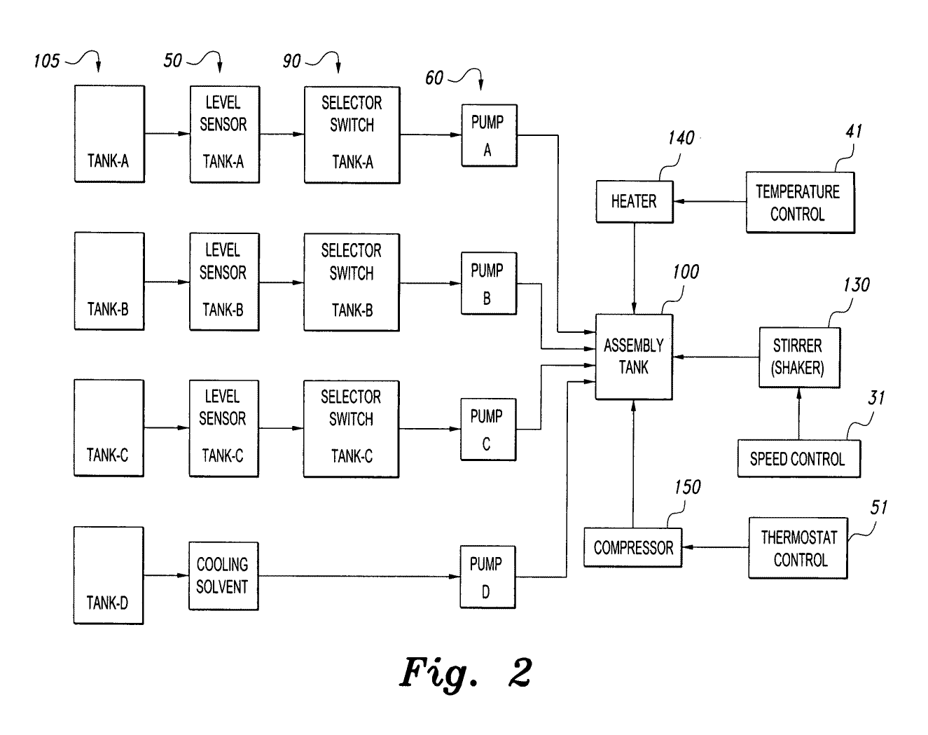

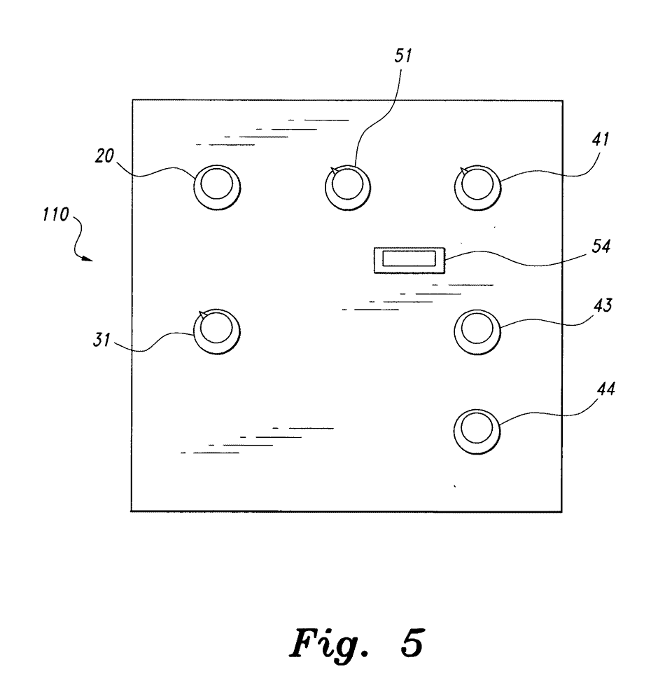

FIG. 5 illustrates a control panel interface 110 and, after completion of the preparation of sample 30, the user may press a completion button 43, thus allowing the user to remove the completed sample and also beginning an automated internal cleaning process of the conduits, etc. of device 1 (step 470). The cleaning process of device 1 may be actuated at any time, not just after production of sample 30, by depressing a cleaning button 44 of control panel 110. As shown in FIGS. 2 and 3, device 1 includes the set of tanks 105, a heater 140, accumulating tank 100, a liquid level sensor and controller 50, a plurality of pumps 60, a temperature controller 41 for heater 140, a stirrer controller 31, a stirrer 130, a cooler 150, such as a compressor cooling system or the like, a temperature controller or thermostat 51 for cooler 150, and a set of selector switches 90. Any suitable type of heater 140 may be used to heat the contents of assembly tank 100. Similarly, any suitable type of cooler 150 may be used to chill the contents of assembly tank 100, and any suitable type of stirrer, mixer or vibrator 130 may be used to stir, mix, vibrate or shake the contents of assembly tank 100. The user may manually actuate each through respective controllers 41, 51, 31, or controllers 41, 51, 31 may be pre-programmed automatic controllers. Alternatively, as will be described in greater detail below, controllers 41, 51, 31 may be in communication with controller 202, or may be integrated as components thereof.

In FIG. 3, device 1 is shown as having a housing 200 to which the control panel 110 is mounted (FIG. 5 illustrates a plan view of control panel 110). Preferably, housing 200 has a drain 120 to drain any liquids collected within housing 200. The assembly tank 100 sits in front of the housing 200, with the housing 200 extending around the sides of the assembly tank 100. The assembly tank 100 sits on an assembly tank holder 130, which contains the heater 140, the cooler 150 and the stirrer 160. Additionally, the conduits 170 leading from the set of tanks 105 is further shown in FIG. 3, positioned above an open end of assembly tank 100.

Additionally, as illustrated in FIG. 2, liquid level sensor and liquid level control switch 50 is associated with each tank of the set of tanks 105. Each liquid level sensor 50 is in communication with controller 202 and with pumps 60 for measuring the volume of liquid drawn out of each tank. Once a desired volume has been drawn off, the control switch deactivates the respective pump. Additionally, separate selector switches 90 may be applied to one or more of the tanks of set 105, allowing for either manual or automatic (under control of controller 202) actuation of the pumps 60. In the example of FIG. 2, three separate samples are provided in tanks A, B and C, and tank D is provided for containing water and/or a cooling solvent for the cleaning process described above.

In the control panel 110 of FIG. 5, the temperature controller 41 for heater 140 is shown as a manual switch. The temperature controller may be a manual on/off type switch, and may be a dial or the like allowing for input of a desired temperature, or may be controlled by controller 202 or otherwise automatically, as described above. An indicator lamp 54 is provided to indicate to the user that the desired temperature has been reached. Similarly, the temperature controller 51 for heater 150 is shown as a manual switch. The temperature controller may be a manual on/off type switch, may be a dial or the like allowing for input of a desired temperature, or may be controlled by controller 202 or otherwise automatically, as described above. Indicator lamp 54 indicates to the user that the desired temperature has been reached. Stirrer control switch 31 is similarly mounted on control panel 110.

When the device 1 is actuated, the samples from the three primary tanks A, B and C of set 105 flow to the accumulating tank 100 and are heated or cooled to the pre-set desired temperature, along with any necessary stirring, set to a desired time. The accumulating tank 100 may be removed from housing 200 and the produced sample can be stored in the accumulating tank 100 or another vessel.

When the process is finished, the user presses the cleaning button 44, at which point the water from tank D will flow thought the path in which the samples passed, thus cleaning the unit. The user then disposes of the water from the accumulating tank 100.

As an example, if a user is conducting an experiment to measure the salt in a crude oil sample, the user may require three samples to perform the experiment, namely crude oil, mixed alcohol and saline. Tanks A, B and C are filled with crude oil, mixed alcohol and saline solution, respectively. The user may then input a desired quantity of crude oil, such as 10 cubic centimeters to be extracted, with level sensor 50 controlling operation of pump 60 to fill the assembly tank 100. The desired quantity may be manually input by the user, or the quantities, properties and instructions for preparation of particular experiments or end result substances may be stored in a database contained in memory 302 of controller 202.

Similarly, 40 cubic centimeters, for example, of the mixed alcohol may be drawn off, as well as a desired quantity of saline, to be mixed together in assembly tank 100. The three separate substances, which were drawn simultaneously and dispensed into assembly tank 100, may then be mixed together, either by manual actuation of the mixer or under automatic control of controller 202, following the instructions stored in the database in the memory 302 for this particular experiment and substance. Similarly, heating and cooling may be manually controlled or automatically controlled by controller 202.

In the alternative embodiment of FIG. 6, system 200 allows for the controlled extraction and manipulation of a plurality of samples. As in the previous embodiment, pumps 60 feed the substances contained within storage tanks 105, under the control of controller 202, to a plurality of sample holders 228 contained within housing 250. As shown in FIG. 6, any desired number of sample holders 228 may be utilized, allowing for the extraction of more than four different substances (such as those contained in tanks A, B, C and D of the previous embodiment).

Any suitable rotatable drive may be used to provide selective and controlled rotation of carousel 226, which is mounted within housing 250, as shown. In FIG. 6, a hydraulic or pneumatic cylinder 224, under the control of controller 202, drives rotation of carousel 226, although it should be understood that this is shown for exemplary purposes only, and that any suitable type of drive system may be utilized.

A beaker 212 (replacing assembly tank 100) is mounted on a sliding platform 210, as shown. Preferably, beaker 212 is mounted on a temperature control unit 214, which may be a Peltier heater/cooler or the like, which rests on platform 210. The temperature control unit 214 is in communication with controller 202 for controlled actuation for the selective heating or cooling of the contents of beaker 212. Sliding platform 210 may be translated by a pneumatic cylinder 216 or the like, in communication with motor 218, or by any other suitable type of linear actuator under the control of controller 202.

Once the contents of the tanks 105 have been pumped into the respective sample holders 228, the platform 210 is slid underneath carousel 226. The carousel 226 is then rotated so that a desired one of the sample holders 228 is positioned beneath plunger 232 of piston 230 (and over the open upper end of beaker 212). Piston 230 may be hydraulic, pneumatic or any other type of linear actuator driven by motor or fluid source 236, under the control of controller 202, to selectively drive plunger 232 into the selected sample holder 228 to dispense a desired volume of the sample into the beaker 212.

Desired volumes of one or more different substances from sample holders 228 may be dispensed into beaker 212. Following dispensing, the platform 210 is then slid back to the position illustrated in FIG. 6, beneath cover 222. Piston 234, which may also be in communication with motor or fluid source 236, lowers cover 222 onto the beaker 212 to seal the upper end thereof. Piston 234 may be a hydraulic piston, a pneumatic piston, a linear actuator or the like, under the control of controller 202. As shown, a thermocouple 244, in communication with controller 202, is mounted to the cover 222 to at least partially project into the contents of beaker 212. Thermocouple 244 is used to measure the temperature of the beaker 212, and the temperature control unit 214 may be actuated to selectively heat or cool the beaker to a desired temperature.

Additionally, motor 220, also under the control of controller 202, may be actuated to shake the platform 210, thus shaking the contents of beaker 212. Any suitable type of shaker or vibrator may be utilized. The amplitude and frequency of vibration is controlled by controller 202. In addition to the shaking, a mixer 242 is rotatably mounted to cover 222, as shown, the mixer 242 being powered by motor 236 to selectively and controllably mix the contents of beaker 212 for a controlled duration and at a controlled rotational velocity.

Following shaking, mixing and temperature adjustment to desired pre-set parameters (via controller 202), the platform 210 is slid to the right (in the orientation of FIG. 6) so that ports 238, 240 formed through cover 222 align with the lower ends 248, 246, respectively, of dispenser tubes 204. External pumps or the like may then be actuated to draw off the contents of beaker 212 to an external dispenser. Valves 206 may be mounted within dispenser 204, as shown, for selective and controlled flow. Alternatively, beaker 212 may simply be removed from within housing 250, as in the previous embodiment, allowing the end result to be stored and transported therein.

FIG. 7 illustrates controller 202, which includes a processor 300 in communication with a display 304, computer readable memory 302 and an interface 306. Data is entered into processor 300 via any suitable type of user interface 306, and may be stored in memory 302, which may be any suitable type of computer readable and programmable memory. Calculations are performed by processor 300, which may be any suitable type of computer processor and may be displayed to the user on display 304, which may be any suitable type of computer display.

Processor 300 may be associated with, or incorporated into, any suitable type of computing device, for example, a personal computer or a programmable logic controller. The display 304, the processor 300, the memory 302 and any associated computer readable recording media are in communication with one another by any suitable type of data bus, as is well known in the art.

Examples of computer readable recording media include a magnetic recording apparatus, an optical disk, a magneto-optical disk, and/or a semiconductor memory (for example, RAM, ROM, etc.). Examples of magnetic recording apparatus that may be used in addition to memory 302, or in place of memory 302, include a hard disk device (HDD), a flexible disk (FD), and a magnetic tape (MT). Examples of the optical disk include a DVD (Digital Versatile Disc), a DVD-RAM, a CD-ROM (Compact Disc-Read Only Memory), and a CD-R (Recordable)/RW.

It is to be understood that the present invention is not limited to the embodiment described above, but encompasses any and all embodiments within the scope of the following claims.

I claim:

1. A sample extraction device, comprising:
a housing defining an open interior region;
a rotating carousel disposed within the housing, the rotating carousel having a plurality of sample holders mounted thereon;
a plurality of sample storage tanks adapted for containing a unique chemical sample;
means for drawing a desired volume of at least one of the chemical samples from a respective one of the plurality of sample storage tanks to a respective at least one of the plurality of sample holders;
means for selectively rotating the rotating carousel so that the desired volume of the at least one chemical sample may be selectively dispensed into a receptacle positioned adjacent the carousel;
means for selectively mixing the at least one chemical sample contained within the receptacle; and
means for dispensing the at least one chemical sample from the receptacle.

2. The sample extraction device as recited in claim 1, wherein said receptacle is selectively positioned beneath said carousel.

3. The sample extraction device as recited in claim 2, further comprising means for selectively heating the at least one chemical sample contained within the receptacle.

4. The sample extraction device as recited in claim 3, further comprising means for selectively cooling the at least one chemical sample contained within the receptacle.

5. The sample extraction device as recited in claim 4, further comprising means for measuring the temperature of the at least one chemical sample contained within the receptacle, the means for measuring the temperature being in communication with said means for selectively heating and said means for selectively cooling the at least one chemical sample for selective actuation and deactuation thereof.

6. The sample extraction device as recited in claim 5, further comprising a cover selectively sealing an open upper end of said receptacle.

7. The sample extraction device as recited in claim 6, further comprising means for selectively covering and uncovering said receptacle with the cover.

8. The sample extraction device as recited in claim 7, wherein said means for selectively mixing the at least one chemical sample and said means for measuring the temperature of the at least one chemical sample are mounted to the cover.

9. The sample extraction device as recited in claim 8, further comprising means for selectively moving said receptacle from beneath said carousel to a position beneath the cover.

10. The sample extraction device as recited in claim 9, wherein said means for selectively moving said receptacle from beneath said carousel to the position beneath the cover comprises a sliding platform, said receptacle and said means for heating and said means for cooling the at least one chemical sample being mounted on the sliding platform.

11. The sample extraction device as recited in claim 10, further comprising means for vibrating the sliding platform.

12. The sample extraction device as recited in claim 1, wherein said housing has a drain formed therethrough.

13. The sample extraction device as recited in claim 1, wherein one of said plurality of sample storage tanks has a cleaning fluid contained therein.

14. A sample extraction device, comprising:
a housing defining an open interior region;
a rotating carousel disposed within the housing, the rotating carousel having a plurality of sample holders mounted thereon;
a plurality of sample storage tanks, each of the tanks being adapted for containing a unique chemical sample;
means for drawing a desired volume of at least one of the chemical samples from a respective one of the plurality of sample storage tanks to a respective at least one of the plurality of sample holders;
means for selectively rotating the rotating carousel so that the desired volume of the at least one chemical sample may be selectively dispensed into a receptacle positioned adjacent the carousel;
means for selectively heating the at least one chemical sample contained within the receptacle;
means for selectively mixing the at least one chemical sample contained within the receptacle; and
means for dispensing the at least one chemical sample from the receptacle.

15. The sample extraction device as recited in claim 14, wherein said receptacle is selectively positioned beneath said carousel.

16. The sample extraction device as recited in claim 15, further comprising means for selectively cooling the at least one chemical sample contained within the receptacle.

17. The sample extraction device as recited in claim 16, further comprising means for measuring the temperature of the at least one chemical sample contained within the receptacle, the means for measuring the temperature being in communication with said means for selectively heating and said means for selectively cooling the at least one chemical sample for selective actuation and deactuation thereof.

18. The sample extraction device as recited in claim 17, further comprising a cover selectively sealing an open upper end of said receptacle.

19. The sample extraction device as recited in claim 18, further comprising means for selectively covering and uncovering said receptacle with the cover.

20. The sample extraction device as recited in claim 19, wherein said means for selectively mixing the at least one chemical sample and said means for measuring the temperature of the at least one chemical sample are mounted to the cover.
